(19) United States
(12) Patent Application Publication
(10) Pub. No.: US 2022/0283401 A1
(43) Pub. Date: Sep. 8, 2022

(54) SYSTEM AND METHOD FOR DYNAMICALLY ADJUSTING MAXIMUM SETTING MAGNIFICATION OF OPTICAL LENS AND NON-TRANSITORY COMPUTER READABLE MEDIUM

(71) Applicant: AVer Information Inc., New Taipei City (TW)

(72) Inventors: Jen-Hung Yeh, New Taipei City (TW); Chao-Hung Chang, New Taipei City (TW); Lien-Kai Chou, New Taipei City (TW)

(21) Appl. No.: 17/653,461

(22) Filed: Mar. 3, 2022

(30) Foreign Application Priority Data
Mar. 4, 2021 (TW) 110107750

(51) Int. Cl. G02B 7/09; G03B 21/53

(52) U.S. Cl. CPC G02B 7/09; G03B 21/53

(57) ABSTRACT

The present disclosure provides a method for dynamically adjusting a maximum setting magnification of an optical lens, and this method includes steps as follows. The object distance is detected; the maximum setting magnification of the zoom lens is adjusted according to the object distance; after the object distance is changed, the object distance is detected to determine the focus mode.

### RELATED APPLICATIONS

This application claims priority to Taiwan Application Serial Number 110107750, filed Mar. 4, 2021, which is herein incorporated by reference.

### BACKGROUND

### Field of Invention

The present invention relates to computer systems and methods, and more particularly, a systems and a method for dynamically adjusting a maximum setting magnification of an optical lens.

### Description of Related Art

Due to a special application of an object projector, the object distance mostly ranges from 50 cm to 5 cm. However, in general, the high-magnification optical zoom lens at the tele end supports a shortest focus distance that is greater than the application of the physical projector.

For example, the 10× lens used by the object projector model M70W has a shortest focus distance of 65 cm at the tele end. Therefore, in order to make the lens conform to the object projector, the maximum magnification supported by the lens must be limited.

For example, three focus modes are designed for the object projector: a normal mode, which supports a focus distance of 10-65 cm and a magnification of 1-3.2×; a macro mode, which supports a focus distance of 5-10 cm, a magnification of 1-2.8×; an infinity mode, which supports a focus distance from 80 cm to infinite, magnification of 1-10×.

The magnification design of each mode must be limited according to the shortest focus distance; this method sacrifices the specification of the lens magnification. For example, when the lens is at an object distance of 30 cm, the physical maximum magnification can be supported to 4.6×, but because the normal mode has the object distance range from 10 cm to 65 cm, and the maximum magnification of the 10 cm object distance is only supported to 3.2×. In this way, the specification of the 30 cm object distance capable of supporting the maximum magnification of 4.6× must be sacrificed.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides a systems and a method for dynamically adjusting a maximum setting magnification of an optical lens, to solve or circumvent aforesaid problems and disadvantages in the related art.

An embodiment of the present disclosure is related to a system for dynamically adjusting a maximum setting magnification of an optical lens, and the system includes a zoom lens, a motor driving element and a processor. The motor driving element is electrically connected to the zoom lens. The processor is electrically connected to the motor driving element, and the processor is configured for: detecting an object distance; adjusting a maximum setting magnification of the zoom lens according to the object distance; detecting the object distance to determine a focus mode after the object distance is changed.

In one embodiment of the present disclosure, the zoom lens has a zoom motor and a focus motor, the processor executes a zoom tracking algorithm to calculate the object distance, after the object distance is changed, the processor uses the focus motor to focus the zoom lens through the motor driving element, and when a defocus aberration occurs, the processor uses the zoom motor to adjust the maximum setting magnification to focus the zoom lens through the motor driving element.

In one embodiment of the present disclosure, the system further includes a time-of-flight measuring element electrically connected to the processor, and the time-of-flight measuring element is configured to obtain a reference object distance as the object distance.

In one embodiment of the present disclosure, the zoom lens has a zoom motor and a focus motor, after the object distance is changed, when the on-the-fly element detects that the object distance increases, the processor uses the focusing motor to focus the zoom lens through the motor driving element, and when the time-of-flying element detects that the object distance decreases, the processor uses the zoom motor to focus the zoom lens through the motor driving element.

In one embodiment of the present disclosure, the system further includes a time-of-flight measuring element electrically connected to the processor, and the time-of-flight measuring element is configured to obtain a reference object distance, and the processor configured to execute a zoom tracking algorithm to calculate the object distance based on the reference object distance.

In one embodiment of the present disclosure, the zoom lens has a zoom motor and a focus motor, after the object distance is changed, when the on-the-fly element detects that the object distance increases, the processor uses the focusing motor to focus the zoom lens through the motor driving element, and when the time-of-flying element detects that the object distance decreases, the processor uses the zoom motor so as to focus the zoom lens through the motor driving element.

Another embodiment of the present disclosure is related to a method for dynamically adjusting a maximum setting magnification of an optical lens, and the method includes steps of: (a) detecting an object distance; (b) adjusting a maximum setting magnification of the zoom lens according to the object distance; (c) detecting the object distance to determine a focus mode after the object distance is changed.

In one embodiment of the present disclosure, the step (a) includes: executing a zoom tracking algorithm to calculate the object distance.

In one embodiment of the present disclosure, the step (b) includes: using a focus motor of the zoom lens to focus the zoom lens, and when a defocus aberration occurs, using a zoom motor of the zoom lens to adjust the maximum setting magnification so as to focus the zoom lens.

In one embodiment of the present disclosure, the step (a) includes: obtaining a reference object distance as the object distance through a time-of-flight measuring element.

In one embodiment of the present disclosure, the step (c) includes: when the on-the-fly element detects that the object distance increases, using a focus motor of the zoom lens to focus the zoom lens, and when the time-of-flying element detects that the object distance decreases, using a zoom motor of the zoom lens to focus the zoom lens.

In one embodiment of the present disclosure, the step (a) includes: obtaining a reference object distance as the object distance through a time-of-flight measuring element, and executing a zoom tracking algorithm to calculate the object distance based on the reference object distance.

In one embodiment of the present disclosure, the step (c) includes: when the on-the-fly element detects that the object distance increases, using a focus motor of the zoom lens to focus the zoom lens, and when the time-of-flying element detects that the object distance decreases, using a zoom motor of the zoom lens to focus the zoom lens.

Yet another embodiment of the present disclosure is related to a non-transitory computer readable medium to store a plurality of instructions for commanding a computer to execute a method for dynamically adjusting a maximum setting magnification of an optical lens, and the method includes steps of: (a) detecting an object distance; (b) adjusting a maximum setting magnification of the zoom lens according to the object distance; (c) detecting the object distance to determine a focus mode after the object distance is changed.

In view of the above, according to the present disclosure, the optical maximum setting magnification is adjusted dynamically according to different object distances. In this way, there is no need to limit the shortest focus distance and to sacrifice the specification of the lens magnification.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a system for dynamically adjusting a maximum setting magnification of an optical lens according to one embodiment of the present disclosure;

FIG. 2 is a flow chart of a method for dynamically adjusting the maximum setting magnification of the optical lens according to one embodiment of the present disclosure;

FIG. 3 is a flow chart of a method for dynamically adjusting the maximum setting magnification of the optical lens according to another embodiment of the present disclosure; and

FIG. 4 is a flow chart of a method for dynamically adjusting the maximum setting magnification of the optical lens according to yet another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It should be noted that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used in the description herein and throughout the claims that follow, the meaning of “a”, “an”, and “the” includes reference to the plural unless the context clearly dictates otherwise.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

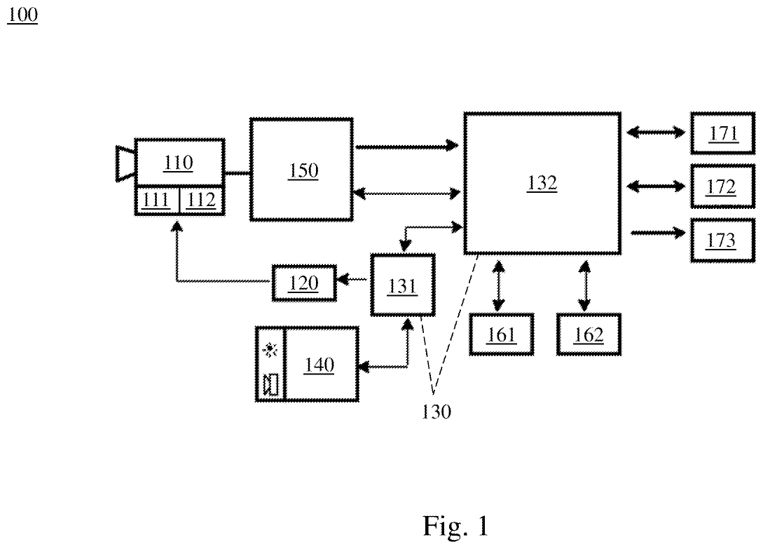

FIG. 1 is a block diagram of a system 100 for dynamically adjusting a maximum setting magnification of an optical lens according to one embodiment of the present disclosure. As shown in FIG. 1, the system 100 can include a zoom lens 110, a motor driving element 120 (e.g., a motor hardware driver), a processor 130, a time-of-flight measuring element 140 (e.g., a time of flight sensor, a time of flight camera and so forth), an image sensing element 150 (e.g., an image sensor), a program register 161, a data register 162, and I/O interfaces 171, 172 and 173. For example, the processor 130 can include a control element 131 (e.g., a controller) and an image processing element 132 (e.g., an image processor).

In structure, the processor 130 is electrically connected to the motor driving element 120, the time-of-flight measuring element 140, the image sensing element 150, the program register 161, the data register 162 and the output/input (I/O) interfaces 171, 172 and 173. The motor driving element 120 is electrically connected to the zoom lens 110. The zoom lens 110 has a zoom motor 111 and a focus motor 112.

In use, the zoom motor 111 is configured to drive the optical zoom lens in the zoom lens 110, so that the focal length of the zoom lens 110 can be changed. The focus motor 112 is configured to drive the optical focus lens of the zoom lens 110, so as to focus the zoom lens 110. The image sensing element 150 converts optical signals into electrical signals. The image processing element 132 sets the working configuration of the image sensing element 150 (e.g., output format, exposure time, etc.) and receives the electrical signal converted by the image sensing element 150; then, the processing processes can include image compression, encoding/decoding, binary value, white balance, edge enhancement, noise reduction, calculation of maximum gradient values and so forth, and the processed image signal can be sent to another receiving element. The motor driving element 120 uses one or more power amplifying elements to amplify/convert one or more input control signals to output one or more driving signals; for example, the power of the output driving signal is higher than the power of the original input control signal. The time-of-flight measuring element 140 is on the basis of an active depth sensing technology, the principle of the time-of-flight measuring element 140 is to resolve the distance between an object and the time-of-flight measuring element 140 by measuring the round trip time of an artificial light, and the basic components of the time-of-flight measuring element 140 include an infrared transmitter and an infrared receiver. The control element 131 receives the signal from the image processing element 132, in which the signal at least contains the maximum gradient value, the control element 131 receives the depth sensing information of the time-of-flight measuring element 140 and obtains the distance between the time-of-flight measuring element 140 and the object, and then the control element 131 combines the above information with the panning/focusing algorithm to outputs one or more control signals to the motor driving element 120 for changing the focal length of the zoom lens 110, so as to focus the zoom lens 110. The program register 161 (e.g., a flash memory) stores the program executed by the image processing element 132, usage settings and so forth. The data register 162 (e.g., a double data rate synchronous dynamic random access memory) temporarily stores the execution program of the image processing element 132, the result of the processing/operation process and so forth. The I/O interfaces 171, 172 and 173 can be various image/data I/O interfaces.

For dynamically adjusting a maximum setting magnification of an optical lens, the processor 130 is configured for: detecting an object distance; adjusting a maximum setting magnification of the zoom lens 110 according to the object distance; detecting the object distance to determine a focus mode after the object distance is changed. In practice, the maximum setting magnification dynamically adjusted by the present disclosure can be equal to or slightly smaller than the maximum magnification physically supported by the zoom lens 110, and those skilled in the art should flexibly choose the value the depending on the actual application.

Specifically, the processor 130 executes a zoom tracking algorithm to calculate the object distance, after the object distance is changed, the processor 130 uses the focus motor 112 to focus the zoom lens 110 through the motor driving element 120. When a defocus aberration of the zoom lens 110 occurs, the processor 130 uses the zoom motor 111 to adjust the maximum setting magnification to focus the zoom lens 110 through the motor driving element 120.

In practice, when the zoom motor 111 moves, the zoom tracking algorithm simultaneously controls the focus motor 112 to maintain the image at a quasi-focus. According to different object distances, different relations between the quasi-focus and the position of the zoom motor 111, in which the relation serves as a lens curve (e.g., Camcurve).

In another embodiment of the present disclosure, the time-of-flight measuring element 140 is configured to obtain a reference object distance as the above object distance. The processor 130 adjusts the maximum setting magnification of the zoom lens 110 according to the object distance. After the object distance is changed, when the on-the-fly element 140 detects that the object distance increases, the processor 130 uses the focusing motor 112 to focus the zoom lens 110 through the motor driving element 120; when the time-of-flying element 140 detects that the object distance decreases, the processor 130 uses the zoom motor 111 to focus the zoom lens 110 through the motor driving element 120.

In yet another embodiment of the present disclosure, the time-of-flight measuring element 140 is configured to obtain a reference object distance, and the processor 130 is configured to execute a zoom tracking algorithm to accurately calculate the object distance based on the reference object distance. The processor 130 adjusts the maximum setting magnification of the zoom lens 110 according to the object distance. After the object distance is changed, when the on-the-fly element 140 detects that the object distance increases, the processor 130 uses the focusing motor 112 to focus the zoom lens 110 through the motor driving element 120; when the time-of-flying element 140 detects that the object distance decreases, the processor 130 uses the zoom motor 111 to focus the zoom lens 110 through the motor driving element 120.

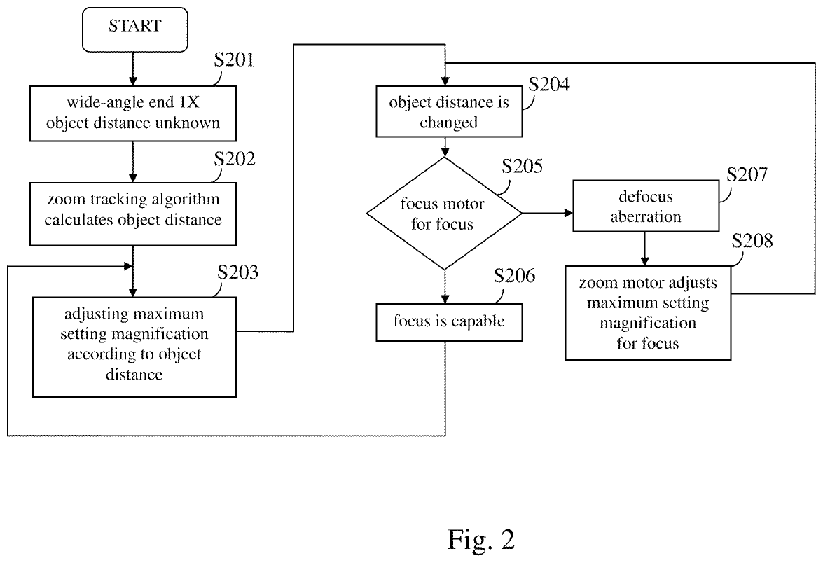

For a more complete understanding of a method for dynamically adjusting the maximum setting magnification of the optical lens, which is performed by the system 100, referring FIGS. 1-2, FIG. 2 is a flow chart of a method 200 for dynamically adjusting the maximum setting magnification of the optical lens according to one embodiment of the present disclosure. As shown in FIG. 2, the method 200 includes operations S201-S208. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In operation S201, The zoom lens 110 of the wide-angle end has a magnification of 1, and the object distance is unknown. In operation S202, the object distance is detected; specifically, the zoom tracking algorithm is executed to calculate the object distance. In operation S203, the maximum setting magnification of the zoom lens 110 is adjusted according to the object distance.

In operation S204, the object distance is changed. After the object distance is changed, in operation S205, the focus motor 112 is used to focus the zoom lens 110. In operation S206, the zoom lens 110 in focus is capable and means that the object distance is increased. Otherwise, the defocus aberration of the zoom lens 110 occurs and means that the object distance is decreased. In operation S208, the zoom motor 111 is used to adjust the maximum setting magnification so as to focus the zoom lens 110.

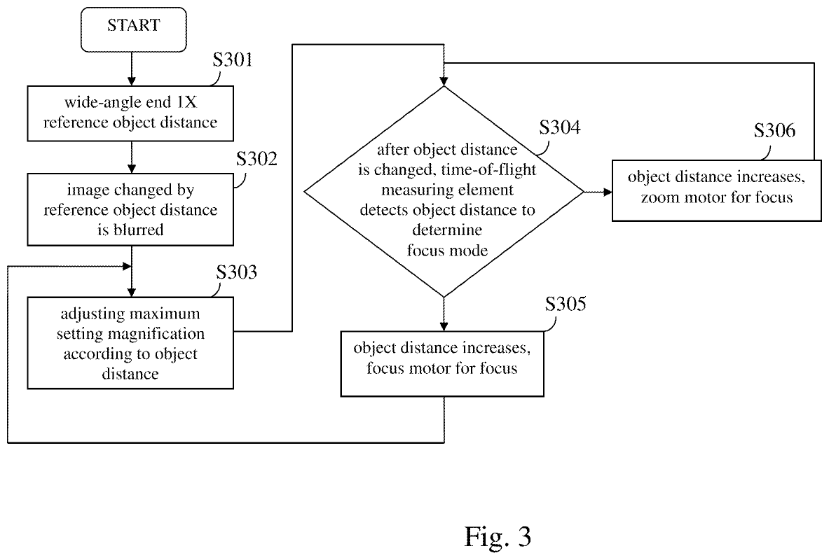

For a more complete understanding of a method for dynamically adjusting the maximum setting magnification of the optical lens, which is performed by the system 100, referring FIGS. 1 and 3, FIG. 3 is a flow chart of a method 300 for dynamically adjusting the maximum setting magnification of the optical lens according to another embodiment of the present disclosure. As shown in FIG. 3, the method 300 includes operations S301-S306. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In operation S301, The zoom lens 110 of the wide-angle end has a magnification of 1, and the time-of-flight measuring element 140 is used to obtain a reference object distance as the object distance. In operation S302, when the image changed by the reference object distance is blurred, the time-of-flight measuring element 140 is used to detect the object distance, in which the new focus object distance can be obtained after the object distance is changed. In operation S303, the maximum setting magnification of the zoom lens 110 is adjusted according to the object distance.

After the object distance is changed, in operation S304, the time-of-flight measuring element 140 detects the object distance so as to determine a focus mode. When the time-of-flight measuring element 140 detects that the object distance increases, in operation S305, the focus motor 112 is used to focus the zoom lens 110. When the time-of-flight measuring element 140 detects that the object distance decreases, in operation S306, the zoom motor 111 is used to focus the zoom lens 110.

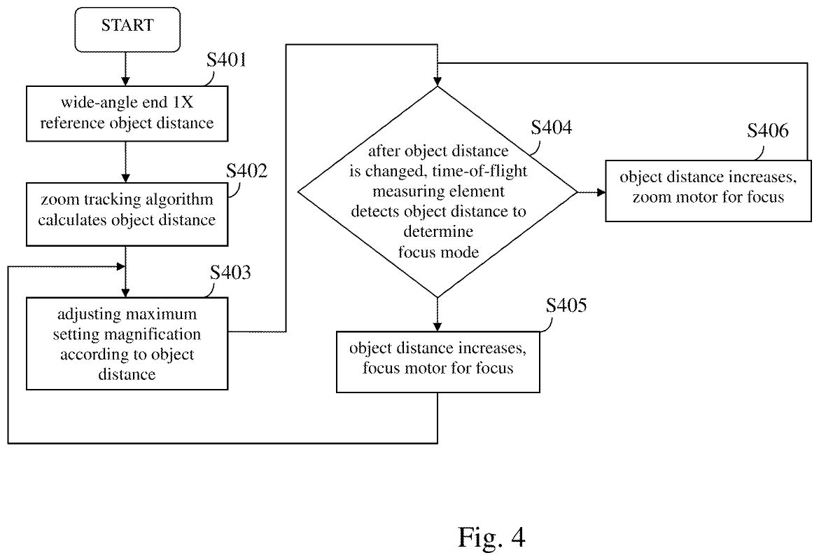

For a more complete understanding of a method for dynamically adjusting the maximum setting magnification of the optical lens, which is performed by the system 100, referring FIGS. 1 and 4, FIG. 4 is a flow chart of a method 400 for dynamically adjusting the maximum setting magnification of the optical lens according to yet another embodiment of the present disclosure. As shown in FIG. 4, the method 400 includes operations S401-S406. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In operation S401, The zoom lens 110 of the wide-angle end has a magnification of 1, and the time-of-flight measuring element 140 is used to obtain a reference object distance as the object distance. In operation S402, the zoom tracking algorithm is executed to accurately calculate the object distance based on the reference object distance. In operation S403, the maximum setting magnification of the zoom lens 110 is adjusted according to the object distance.

After the object distance is changed, in operation S404, the time-of-flight measuring element 140 detects the object distance so as to determine a focus mode. When the time-of-flight measuring element 140 detects that the object distance increases, in operation S405, the focus motor 112 is used to focus the zoom lens 110. When the time-of-flight measuring element 140 detects that the object distance decreases, in operation S406, the zoom motor 111 is used to focus the zoom lens 110.

The methods 200, 300 and 400 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In view of the above, according to the present disclosure, the optical maximum setting magnification is adjusted dynamically according to different object distances. In this way, there is no need to limit the shortest focus distance and to sacrifice the specification of the lens magnification.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system for dynamically adjusting a maximum setting magnification of an optical lens, the system comprising:
a zoom lens;
a motor driving element electrically connected to the zoom lens; and
a processor electrically connected to the motor driving element, and the processor configured for:
detecting an object distance;
adjusting a maximum setting magnification of the zoom lens according to the object distance; and
detecting the object distance to determine a focus mode after the object distance is changed.

2. The system of claim 1, wherein the zoom lens has a zoom motor and a focus motor, the processor executes a zoom tracking algorithm to calculate the object distance, after the object distance is changed, the processor uses the focus motor to focus the zoom lens through the motor driving element, and when a defocus aberration occurs, the processor uses the zoom motor to adjust the maximum setting magnification to focus the zoom lens through the motor driving element.

3. The system of claim 1, further comprising:
a time-of-flight measuring element electrically connected to the processor, and the time-of-flight measuring element configured to obtain a reference object distance as the object distance.

4. The system of claim 3, wherein the zoom lens has a zoom motor and a focus motor, after the object distance is changed, when the on-the-fly element detects that the object distance increases, the processor uses the focusing motor to focus the zoom lens through the motor driving element, and when the time-of-flying element detects that the object distance decreases, the processor uses the zoom motor to focus the zoom lens through the motor driving element.

5. The system of claim 1, further comprising:
a time-of-flight measuring element electrically connected to the processor, and the time-of-flight measuring element configured to obtain a reference object distance, and the processor configured to execute a zoom tracking algorithm to calculate the object distance based on the reference object distance.

6. The system of claim 5, wherein the zoom lens has a zoom motor and a focus motor, after the object distance is changed, when the on-the-fly element detects that the object distance increases, the processor uses the focusing motor to focus the zoom lens through the motor driving element, and when the time-of-flying element detects that the object distance decreases, the processor uses the zoom motor so as to focus the zoom lens through the motor driving element.

7. A method for dynamically adjusting a maximum setting magnification of an optical lens, and the method comprising steps of:
(a) detecting an object distance;
(b) adjusting a maximum setting magnification of the zoom lens according to the object distance; and
(c) detecting the object distance to determine a focus mode after the object distance is changed.

8. The method of claim 7, wherein the step (a) comprises:
executing a zoom tracking algorithm to calculate the object distance.

9. The method of claim 8, wherein the step (b) comprises:
using a focus motor of the zoom lens to focus the zoom lens, and when a defocus aberration occurs, using a zoom motor of the zoom lens to adjust the maximum setting magnification so as to focus the zoom lens.

10. The method of claim 7, wherein the step (a) comprises:
obtaining a reference object distance as the object distance through a time-of-flight measuring element.

11. The method of claim 10, wherein the step (c) comprises:
when the on-the-fly element detects that the object distance increases, using a focus motor of the zoom lens to focus the zoom lens, and when the time-of-flying element detects that the object distance decreases, using a zoom motor of the zoom lens to focus the zoom lens.

12. The method of claim 7, wherein step (a) comprises:
obtaining a reference object distance as the object distance through a time-of-flight measuring element, and executing a zoom tracking algorithm to calculate the object distance based on the reference object distance.

13. The method of claim 12, wherein step (c) comprises:
when the on-the-fly element detects that the object distance increases, using a focus motor of the zoom lens to focus the zoom lens, and when the time-of-flying element detects that the object distance decreases, using a zoom motor of the zoom lens to focus the zoom lens.

14. A non-transitory computer readable medium to store a plurality of instructions for commanding a computer to execute a method for dynamically adjusting a maximum setting magnification of an optical lens, and the method comprising:
(a) detecting an object distance;
(b) adjusting a maximum setting magnification of the zoom lens according to the object distance; and
(c) detecting the object distance to determine a focus mode after the object distance is changed.

15. The non-transitory computer readable medium of claim 14, wherein the step (a) comprises:
executing a zoom tracking algorithm to calculate the object distance.

16. The non-transitory computer readable medium of claim 15, wherein the step (b) comprises:
using a focus motor of the zoom lens to focus the zoom lens, and when a defocus aberration occurs, using a zoom motor of the zoom lens to adjust the maximum setting magnification so as to focus the zoom lens.

17. The non-transitory computer readable medium of claim 14, wherein the step (a) comprises:
obtaining a reference object distance as the object distance through a time-of-flight measuring element.

18. The non-transitory computer readable medium of claim 17, wherein the step (c) comprises:
when the on-the-fly element detects that the object distance increases, using a focus motor of the zoom lens to focus the zoom lens, and when the time-of-flying element detects that the object distance decreases, using a zoom motor of the zoom lens to focus the zoom lens.

19. The non-transitory computer readable medium of claim 14, wherein the step (a) comprises:
obtaining a reference object distance as the object distance through a time-of-flight measuring element, and executing a zoom tracking algorithm to calculate the object distance based on the reference object distance.

20. The non-transitory computer readable medium of claim 19, wherein the step (c) comprises:
when the on-the-fly element detects that the object distance increases, using a focus motor of the zoom lens to focus the zoom lens, and when the time-of-flying element detects that the object distance decreases, using a zoom motor of the zoom lens to focus the zoom lens.
